(19) United States
(12) Patent Application Publication
(10) Pub. No.: US 2002/0198725 A1
(43) Pub. Date: Dec. 26, 2002

(54) Method and system for managing a relationship with a venture company

(75) Inventors: John Otto Piepenbrink, Manteno, IL (US); John Arthur Ricketts, Willowbrook, IL (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 09/886,160

(22) Filed: Jun. 21, 2001

(51) Int. Cl. G06F 17/60

(52) U.S. Cl. 705/1

(57) ABSTRACT

A method and system for managing a relationship with a venture company. Specifically, the present invention provides a process for a business entity to analyze a relationship opportunity with a venture company. The process has four phases, namely, identification, screening, evaluation, and deployment. In addition, the present invention provides a database system for efficiently managing relationship information corresponding to the process.

### BACKGROUND OF THE INVENTION

1. Technical Field

The present invention generally relates to a method and system for managing a relationship with a venture company. In particular, the present invention provides a process for evaluating a relationship opportunity with a venture company and a system for managing relationship information corresponding to the process.

2. Background Art

In today's accelerated business environment, business entities are increasingly pursuing new business models in an effort to increase profits. For example, new venture companies are rapidly forming in an effort to capitalize on the recent growth of the Internet. Oftentimes, these new venture companies seek relationships with established business entities in order to acquire funding, experience, technology, and other essential resources. These relationships can take many forms such as equity investments, pricing, arrangements, and alliances.

Relationships between existing business entities and new venture companies have become so commonplace that many existing business entities have formed internal groups (e.g., new venture groups) to coordinate and manage each relationship. Moreover, a relationship between an internal group and a venture company is often complicated and develops over a period of several months. Specifically, the venture company must usually first communicate venture information (e.g., business plan, financial data, goals for the relationship, etc.) to the internal group. The internal group will then review the submitted information and analyze any relationship opportunities with the venture company.

As indicated, this process could take at least several months and have several phases. In addition, the process is often too lengthy and complicated to be performed or managed as a single unit of work. Heretofore, the process was performed manually by numerous individuals each having their own set of responsibilities. When performed in such a manner, however, management of the relationship (including the analysis process) was often disjointed and inefficient.

In addition, an internal group of existing business entities generally has different objectives for a relationship opportunity than does a venture capitalist or an investment banker. Specifically, venture capitalists and investment bankers usually seek a return on their investment through an initial public offering. In contrast, an existing business entity will generally seek a return on their investment through the direct practice of the venture company's business plan. However, no current processes exist that are tailored to meet the needs and objectives of an existing business entity

In view of the forgoing, there exists a need fir a standardized process for an existing business entity to analyze a relationship opportunity with a venture company. In addition, a need for exists for a method and system for managing a relationship with a venture company.

### SUMMARY OF THE INVENTION

The present invention overcomes the drawbacks of existing systems by providing a method and system for managing a relationship with a venture company. The method and system include, among other things, a process for analyzing a relationship opportunity with a venture company and a system for managing relationship information corresponding to the process.

According to a first aspect of the present invention, a method for managing a relationship with a venture company is provided. The method comprises the steps of: (1) providing venture information pertaining to the venture company; (2) entering the venture information into a database having a column-row matrix of records, wherein the venture information is entered on a current date; and (3) querying a row of the database to provide a single record of relationship information pertaining to the venture company.

According to a second aspect of the present invention, a method for managing a relationship with a venture company is provided. The method comprises the steps of: (1) providing venture information pertaining to the venture company, and providing scoring data based on the venture information; (2) entering the venture information and scoring data into a database having a column-row matrix of records, wherein the venture information and scoring data are entered on a current date; (3) querying a row of the database to provide a single record of relationship information pertaining to the venture company; (4) duplicating the single record from a first column of the queried row to a second column of the queried row; and (5) assigning an updated current date to the duplicated record.

According to a third aspect of the present invention, a method for analyzing a relationship opportunity with a venture company is provided. The method comprises the steps of: (1) identifying a relationship opportunity with a venture company and obtaining venture information about the venture company; (2) logging an identification status in a database; (3) calculating scoring data based on the venture information; (4) logging a screening status in the database; (5) evaluating the scoring data to determine whether to form a business relationship with the venture company; (6) logging an evaluation status in the database; and (7) deploying the business relationship if the scoring data was positively evaluated.

According to a fourth aspect of the present invention, a system for managing a relationship with a venture company is provided. The system comprises: (1) a process system for analyzing a relationship opportunity with a venture company; (2) a library system for providing library elements; and (3) a view system for providing a plurality of views of the process, and the library elements.

According to a fifth aspect of the present invention, a system for managing a relationship with a venture company is provided. The system comprises: (1) a process system for analyzing a relationship opportunity with a venture company; (2) a library system for providing reference documentation, templates, and a screening tool; (3) a database system for managing relationship information corresponding to the process; and (4) a view system for providing a plurality of views of the process, the reference documentation, the templates, the screening tool, and the relationship information.

According to a sixth aspect of the present invention, a system for managing a relationship with a venture company is provided. The system comprises: (1) a process system for analyzing a relationship opportunity with a venture company; (2) a library system for providing reference documentation, templates, and a screening tool; (3) a database system for managing relationship information corresponding to the process, wherein the database system comprises: (a) a database having a column-row matrix of records, wherein each row corresponds to a separate venture company, and wherein each column corresponds to a separate time interval; (b) a row query system for querying a row of the matrix to provide a single record of relationship information corresponding to a particular venture company at a predetermined time interval; (c) a duplication system for duplicating a provided single record from a first column of a queried row to a second column of the queried row; (d) a dating system for assigning an updated current date to a duplicated record; and (4) a view system for providing a plurality of views of the process, the reference documentation, the templates, the screening tool, and the relationship information.

According to an seventh aspect of the present invention, a database system for managing relationship information corresponding to a process for analyzing a relationship opportunity with a venture company is provided. The database system comprises: (1) a database having a column-row matrix of records, wherein each row corresponds to a separate venture company, and wherein each column corresponds to a separate time interval; and (2) a row query system for querying a row of the matrix to provide a single record of relationship information corresponding to a particular venture company at a predetermined time interval.

According to an eighth aspect of the present invention, a database system for managing relationship information corresponding to a process for analyzing a relationship opportunity with a venture company is provided. The database system comprises: (1) a database having a column-row matrix of records, wherein each row corresponds to a separate venture company, and wherein each column corresponds to a separate time interval; (2) a row query system for querying a row of the matrix to provide a single record of relationship information corresponding to a particular venture company at a predetermined time interval; (3) a duplication system for duplicating a provided single record from a first column of a queried row to a second column of the queried row; and (4) a dating system for assigning an updated current date to a duplicated record.

According to a ninth aspect of the present invention, a program product stored on a recordable medium for managing a relationship with a venture company is provided. The program product comprises: (1) a process system for analyzing a relationship opportunity with the venture company; (2) a library system for providing reference documentation, templates, and a screening tool; and (3) a view system for providing a plurality of views of the process, the reference documentation, the templates, and the screening tool.

Therefore, the present invention provides a method and system for managing a relationship with a venture company.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 depicts a computer system having a relationship management system, according to the present invention.

FIG. 2 depicts a box diagram of the relationship management system of FIG. 1.

FIG. 3 depicts a box diagram of a process system of the relationship management system.

FIG. 4 depicts a first checklist of a process for analyzing a relationship opportunity with a venture company.

FIG. 5 depicts a second checklist of a process for analyzing a relationship opportunity with a venture company.

FIG. 6 depicts a box diagram of a library system of the relationship management system.

FIG. 7 depicts a box diagram of a database system of the relationship management system.

FIG. 8 depicts a first column-row matrix of records having relationship information.

FIG. 9 depicts a second column-row matrix of records having relationship information.

FIG. 10 depicts a first view of library elements.

FIG. 11 depicts a second view of library elements.

FIG. 12 depicts a first view of process elements.

FIG. 13 depicts a second view of process elements.

FIG. 14 depicts a view of relationship information.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience, this description will include the following sections:

I. Definitions

II. Computer System

III. Relationship Management System

IV. Process System

A. Process

V. Library System

VI. Database System

VII. Views

I. Definitions

Venture Company—a new business entity that is seeking a relationship with an existing business entity.

Relationship—a merger, alliance, equity investment, or other business arrangement between an existing business entity and a venture company.

Internal Group—a group or department within an existing business entity that evaluates/analyzes a relationship opportunity with a venture company

Venture Information—information pertaining to a venture company (e.g., business plan, customers, predicted sales, etc.)

Process—the procedure a business entity will follow when analyzing a relationship opportunity with a venture company.

Relationship Information—information gathered during the process of analyzing of a relationship opportunity with a venture company (e.g., process status, venture information, etc.).

Set—a group of zero or more (e.g., activities, tasks, steps, etc.).

Screening Tool—a document used by a business entity to arrange venture information.

Process Elements—the phases, activities, tasks and steps in a process.

Library Elements—reference documentation, templates, and screening tools.

II. Computer System

Generally stated, the present invention provides a method and system for managing a relationship with a venture company. Specifically, the present invention provides a process for analyzing a relationship opportunity with an entity, and a database system for managing relationship information corresponding to the process. The process of the present invention provides a uniform way for existing business entities to analyze relationship opportunities. As discussed above, existing business entities have different goals for forming relationships with venture companies than do venture capitalists or investment bankers. Moreover, the database system allows for relationship information corresponding to the process to be efficiently managed and accessed

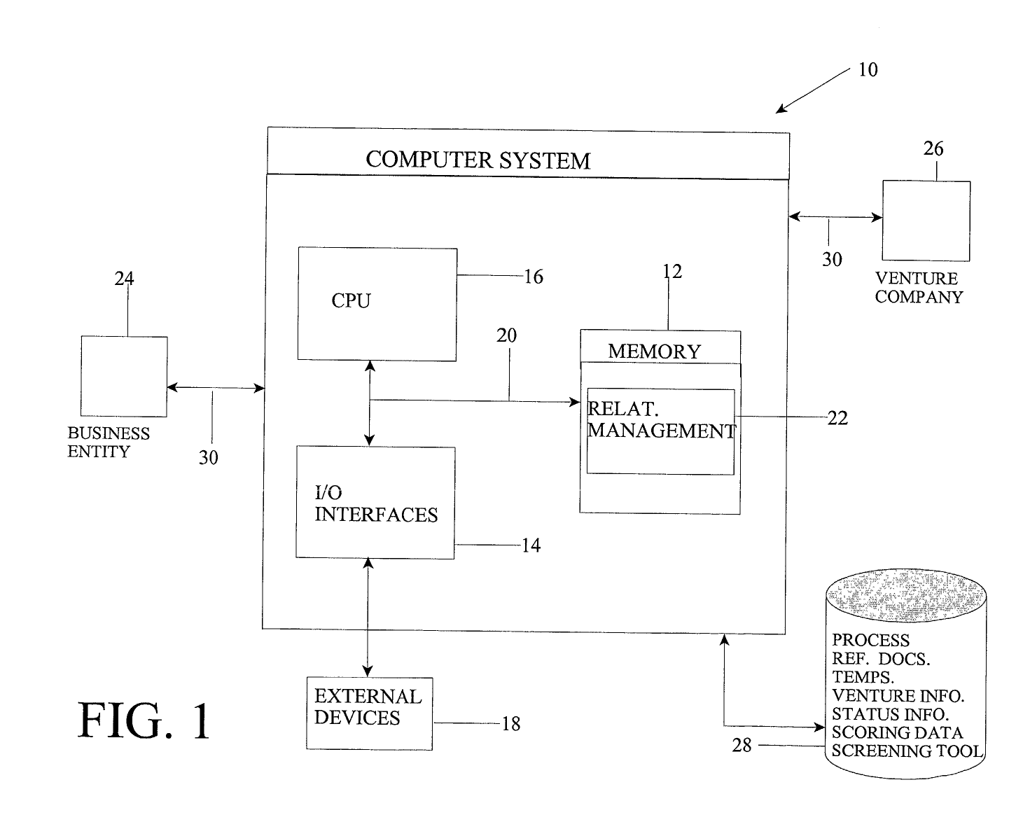

Referring now to FIG. 1, a computer/server system 10 that includes the relationship management system 22 of the present invention is shown. The computer system 10 generally comprises memory 12, input/output interfaces 14, a central processing unit (CPU) 16, external devices/resources 18, bus 20, and database 28. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. External devices 18 may comprise any known type of external device, including a CRT, LED screen, hand-held device, keyboard, mouse, voice recognition system, speech output system, printer, facsimile, pager, personal digital assistant, cellular phone, web phone, etc. Bus 20 provides a communication link between each of the components in the computer system 10 and likewise may comprise any known type of transmission link, including electrical, optical, wireless, etc. In addition, although not shown, additional components, such as cache memory, communication systems, system software, etc., maybe incorporated into computer system 10.

Stored in memory 12 is relationship management system 22 (shown in FIG. 1 as a software product). Relationship management system 22 will be described in more detail below but generally comprises a method and system for managing a relationship with a venture company 26. Database 28 provides storage for information necessary to carry out the present invention. Such information could include, inter alia: (1) the process for analyzing a relationship opportunity with entity 26; (2) reference documentation useful in the process; (3) templates useful in the process; (4) venture information; (5) process status information; (6) scoring data; and (7) a screening tool for arranging venture information. Database 28 may comprise one or more storage devices, such as a magnetic disk drive or an optical disk drive. In another preferred embodiment, database 28 includes data distributed across, for example, a local area network (LAN), wide area network (WAN) or a storage area network (SAN) (not shown). Database 28 may also be configured in such a way that one of ordinary skill in the art may interpret it to include one or more databases.

As will be described in further detail below, venture company 26 provides venture information to computer system 10. Such information preferably includes information useful in analyzing a relationship opportunity with venture company 26 (e.g., a business plan, customers, proposed sales, etc.). A process (as will be further described below) is then followed by business entity 24 to determine whether to seize the opportunity and form a relationship with venture company 26. During the process, relationship information will be stored in database 28. Database 28 is managed such that business entity 24 can efficiently access the information stored therein.

Communication with computer system 10 by business entity 24 or venture company 26 occurs via communication links 30. Communications links 30 can include a direct terminal connected to the computer system 10, or a remote workstation in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system.

It is understood that the present invention can be realized in hardware, software, or a combination of hardware and software. As indicated above, the computer system 10 according to the present invention can be realized in a centralized fashion in a single computerized workstation, or in a distributed fashion where different elements are spread across several interconnected computer systems (e.g., a network). Any kind of computer system—or other apparatus adapted for carrying out the methods described herein—is suited. A typical combination of hardware and software could be a general purpose computer system with a computer program that, when loaded and executed, controls the computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

III. Relationship Management System

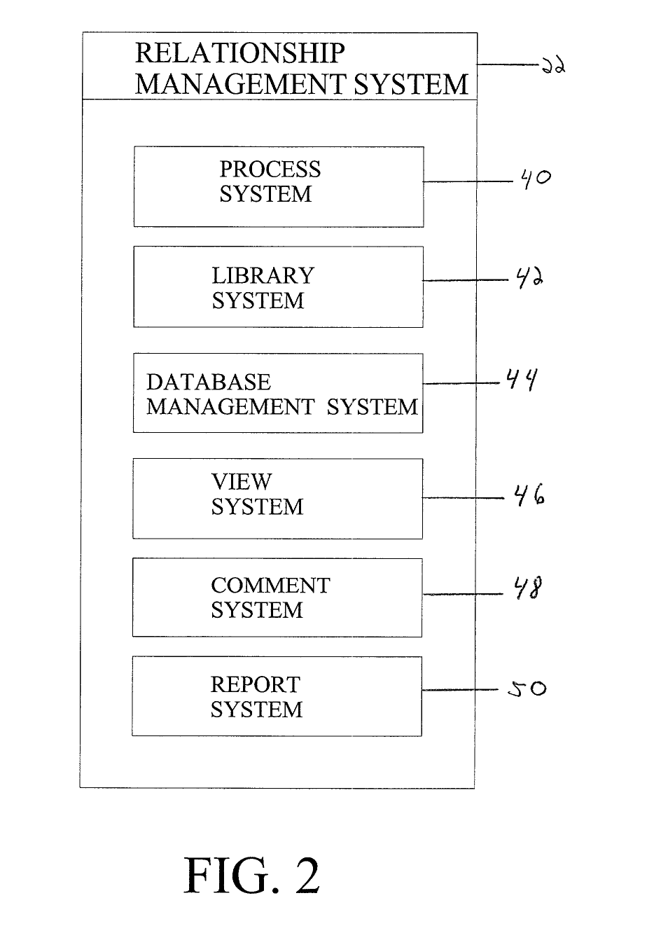

Referring now to FIG. 2, relationship management system 22 is shown in greater detail. As depicted, relationship management system 22 includes process system 40, library system 42, database management system 44, view system 46, comment system 48, and report system 50. These systems will be further described below, but generally, process system 40 accesses the database to provide a process for analyzing a relationship opportunity with a venture company. Depending on the type of opportunity being proposed, the process could vary. Library system 42 accesses the database to provide library elements such as reference documentation and templates useful in carrying out the process. In addition, library system 42 also provides a screening tool that a business entity can use to uniformly arrange venture information. Database management system 44 interfaces with the database to efficiently manage information stored therein. Collectively, database management system 44 and the database will be referred to as the database system. View system 46 provides a plurality of views of: (1) the process (i.e., process elements); (2) templates, reference documentation, and the screening tool (library elements); and (3) relationship information.

Comment system 48 allows the business entity to post comments regarding the process or other components of the relationship management system. Moreover, comment system also allows the business entity to comment on a previous comment. Preferably, comment system 48 comprises an interface such as a world wide web browser or the like that the business entity could use to input their comments. Report system 50 generates and outputs reports related to the process. Specifically, if the business entity is analyzing a relationship opportunity with a particular venture company, report system 50 can provide reports related to process status, financial projections, etc. Such reports can be provided as a hard copy or in electronic format.

It should be appreciated that this description of relationship management system 22 is for illustrative purposes only and relationship management system 22 can take many different forms. For example, comment system 48 and view system 46 could exist as a single system.

IV. Process System

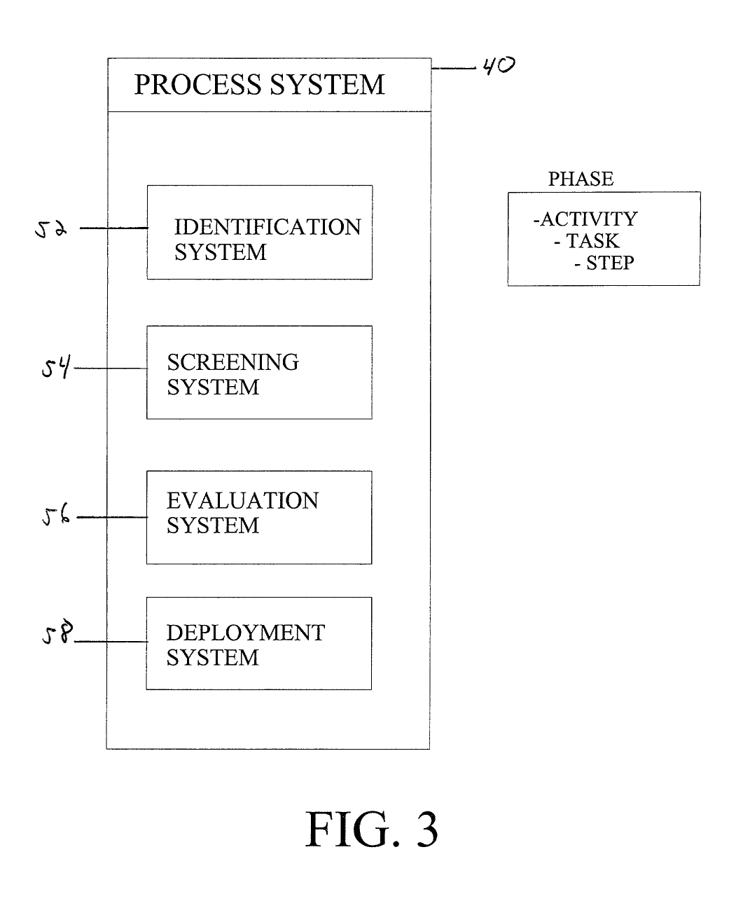

Referring now to FIG. 3, process system 40 is shown in greater detail. As described above, process system 40 accesses the database to provide the business entity with a process for analyzing a relationship opportunity with the venture company. Preferably, the process has a hierarchy of process elements. Specifically, the process preferably has four phases, namely, identification, screening, evaluation, and deployment. Each phase preferably has a set of activities, each activity has a set of tasks, and each task has a set of steps. The process is specifically tailored so the business entity can efficiently determine whether to enter into the proposed relationship with the venture company. In general, the goal of the identification phase is to identify the relationship opportunity and obtain any necessary information from the venture company (i.e., venture information). The screening phase is when the opportunity will be scored based on the venture information and the goals of the business entity. The evaluation phase is when the scored opportunity will be evaluated and a determination of whether to proceed with the relationship is made (e.g., including due diligence). If the opportunity is positively evaluated, the deployment phase will coordinate any necessary actions for proceeding with the relationship.

By breaking the process into phases and smaller units of work, the overall process is substantially easier to manage. As depicted in FIG. 3, each phase could be individually provided by a separate system. For example, identification system 52 could access the database to provide the business entity with the process elements in the identification phase (i.e., identification phase activities, tasks, and steps). Screening system 54 could access the database to provide the process elements in the screening phase. Evaluation system 56 could access the database to provide the process elements in the evaluation phase. Deployment system 58 could access the database to provide the process elements in the deployment phase. However, it should be understood that in lieu of four separate systems, one system could be implemented that accesses the database and provides all process elements. In this case, the process could still be provided in phases, or all at once.

A. Process

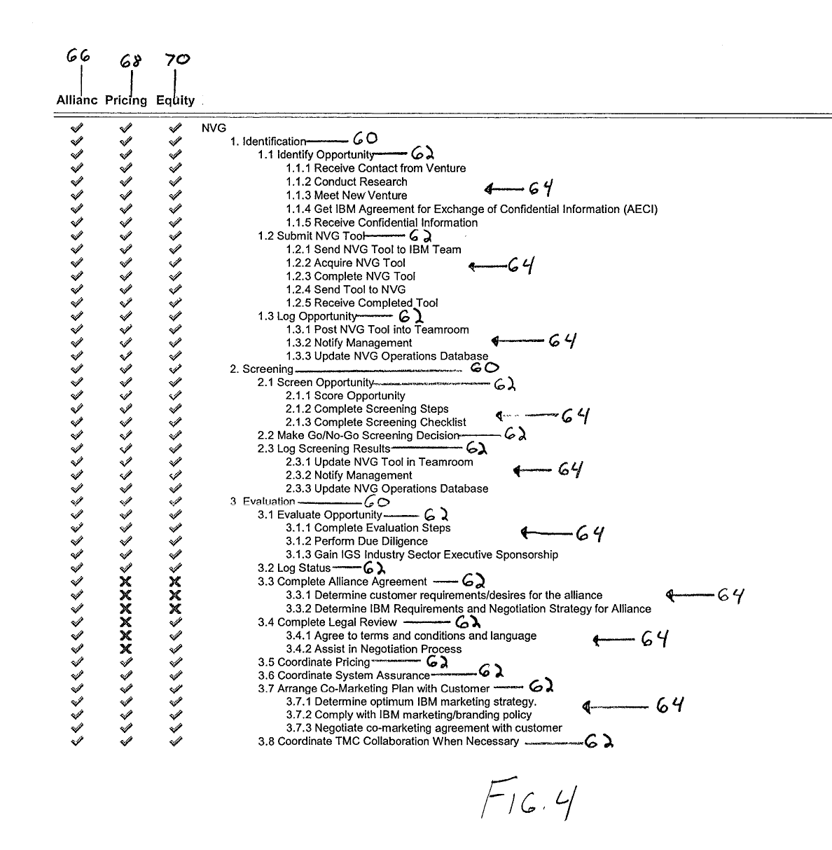

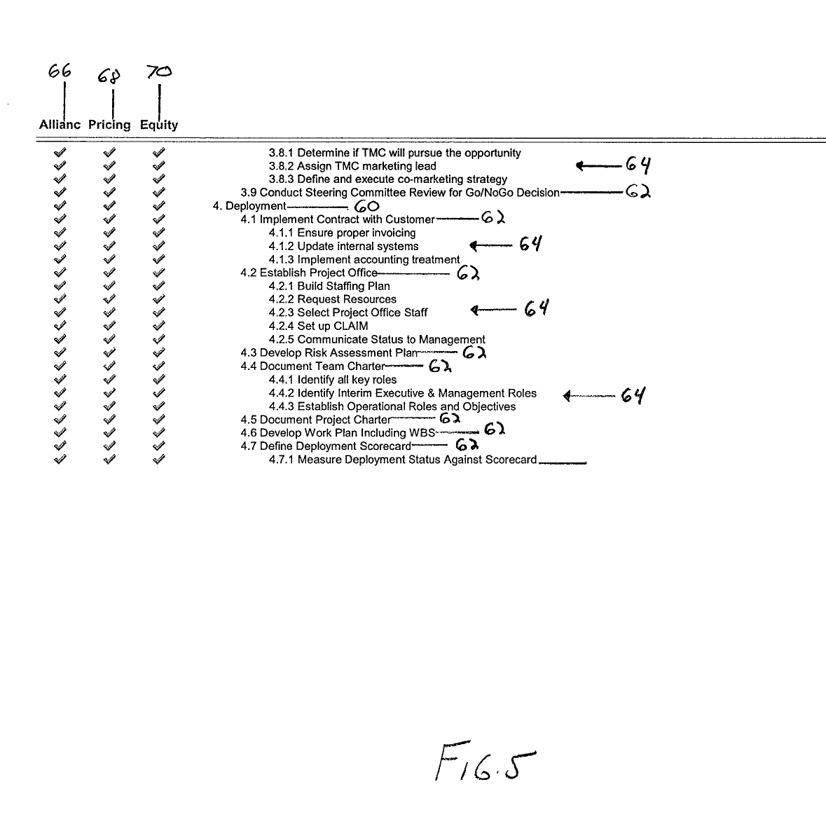

Referring now to FIGS. 4 and 5, all phases 60, activities 62, and tasks 64 in the process are depicted. The steps in each task are not depicted for brevity purposes. The business entity will execute the process to analyze a relationship opportunity with the venture company. In executing the process, the business entity can, among other things, generate any necessary reports and make any comments.

As shown, identification phase 60 includes the activities 62 of: (1) identify opportunity; (2) submit tool; and (3) log opportunity, Each activity 62 also includes a set of tasks 64 necessary for carrying-out the activity. Identification phase 60 allows the business entity to gather any necessary venture information so that the process can be efficiently run.

Screening phase 60 includes the activities 62 of: (1) screen opportunity; (2) make screening decision; and (3) log screening results. As depicted, some activities 62 in screening phase 60 also have a set of corresponding tasks 64. Screening phase 60 allows the business entity to calculate scoring data based on the venture information and other factors. Specifically, the business entity could review the venture information and assign scores to based on various criteria. For example, the relationship opportunity might be assigned the following scores:

Financial Potential—7 out of 10;

Predicted Longevity of Relationship—6 out of 10;

It should be understood, however, that these scores are intended to be illustrative only and many other variations for scoring and criteria exist.

Evaluation phase 60 includes the activities 62 of: (1) evaluate opportunity; (2) log status; (3) complete alliance agreement; (4) complete legal review; (5) coordinate pricing; (6) coordinate system assurance; (7) arrange co-marketing plan; (8) coordinate collaboration when necessary; and (9) conduct steering committee review for final (i.e., go/no go decision). Moreover, evaluation phase 60 also includes tasks 64. Evaluation phase 60 is where the business entity will review the scores to determine whether to proceed with the relationship. For example, the business entity could base its decision on the total score calculated during screening phase 60. Specifically, a total of less than 15 could mean “do not proceed.” It should be understood that the precise methodology used to evaluate based on the scores is not intended to be limiting. For example, the business entity could multiply the scores.

Deployment phase 60 has the activities 62 of: (1) implement contract with customers; (2) establish project office; (3) develop risk assessment plan; (4) document team charter; (5) document project charter; (6) develop work plan; and (7) define deployment scorecard. Similar to the above phases, deployment phase 60 also includes various tasks 64. Deployment phase 60 occurs when the relationship is positively evaluated during the evaluation phase 60. Specifically, it coordinates any necessary actions for the relationship to proceed. As shown and described in conjunction with FIGS. 4 and 5, the identification, screening, and evaluation phases all allow for a status to be logged in the database. This allows the status of an analysis to be tracked for each venture company.

As indicated above, the process is performed to evaluate an opportunity with a venture company. It should be understood that the process could be performed by an individual or group of individuals within the business entity. Preferably, the process is performed by an individual or group of individuals within an internal group within the business entity. The process shown is intended to give a business entity a complete time line of events that should/must occur when analyzing a relationship opportunity with a venture company. It should be appreciated, however, that certain process elements could be performed in parallel. For example, the tasks 64 “receive contract from venture” and “conduct research tasks” in identification phase 60 could be performed at the same time.

In addition, FIGS. 4 and 5 depict the process for three types of relationships: (1) alliance 66; (2) equity 68; (3) and pricing 70. An alliance relationship 66 is where joint action on the part of the venture company and the business entity is required. For example, the business entity may provide information technology infrastructure and services in support of the venture company's business plan. An equity relationship 68 is where the business entity takes an equity stake in the venture company. A pricing relationship 70 is a services relationship between the business entity and the venture company that is driven based on something other than billable hours (e.g., a fixed fee). As shown, all steps do not necessarily apply to all relationship types. For example, the complete alliance agreement activity 62 of the evaluation phase 60 only applies to alliance relationship 66. Moreover, the complete legal review activity 62 of the evaluation phase does not apply to pricing relationship 68. This allows the process to be tailored based on the particular type of relationship be presented so that maximum efficiency in reviewing the relationship opportunity is obtained.

V. Library System

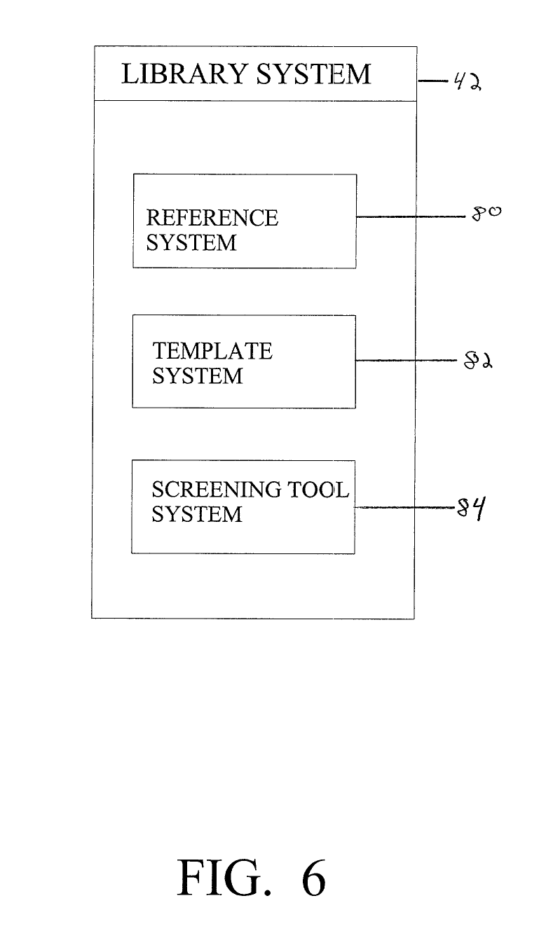

Referring now to FIG. 6, library system 42 is shown in greater detail. Library system 42 accesses the database to provide any needed library elements. Specifically, library system 42 preferably includes reference system 80, template system 82, and screening tool system 84. Reference system 80 accesses the database to provide reference documentation. For example, the business entity running the above process reference could require a set of diagrams. Reference system 80 accesses the database to provide any such documentation or hypertext links. Template system 82 accesses the database to provide any templates that are used during the process. Specifically, one task in the process is to make an agreement with the venture company for the exchange of confidential information. In performing this task, the business entity could utilize template system 82 to provide a standard form for such an agreement. Screening tool system 84 accesses the database to provide the screening tool. The screening tool is preferably a document (e.g., on-line or hard copy) that the business entity will complete based on the received venture information. Specifically, the screening tool allows the business entity to arrange received venture information in a common format. By arranging the venture information in a common format, the business entity can easily verify that all information necessary to execute the process has been provided. Preferably, the venture information is provided by the venture company to the business entity (e.g., verbally, by hard copy, or electronically). The business entity can then arrange the provided information in the screening tool.

VI. Database System

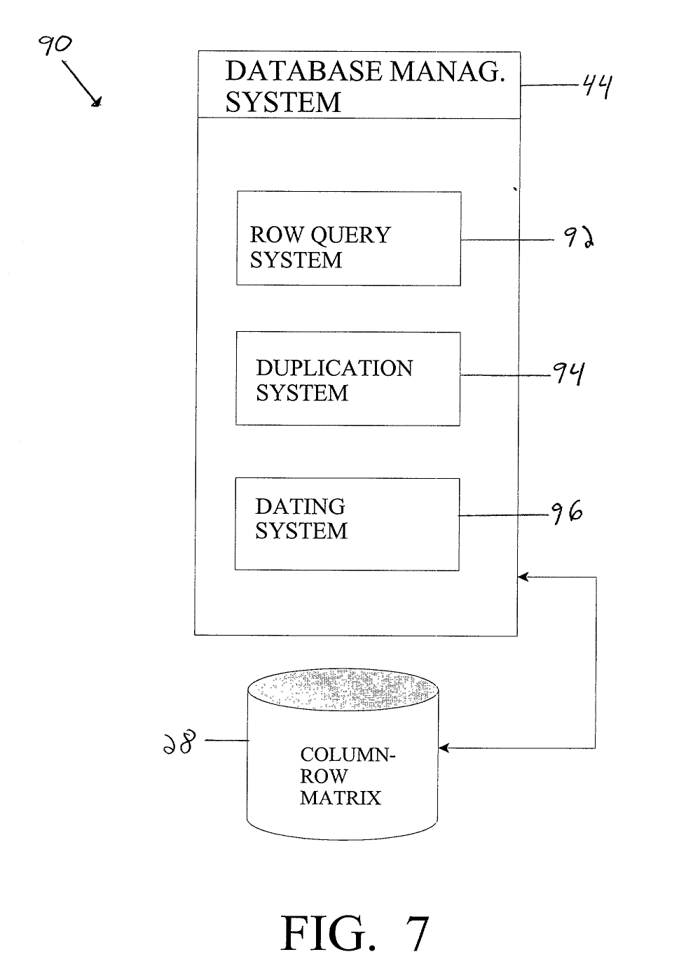

Referring now to FIG. 7, a database system 90 is shown. As depicted, database system 90 includes database management system 44 (i.e., of the relationship management system) and database 28. Database management system 44 includes row query system 92, duplication system 94, and dating system 96 (to be further described below). As indicated above, in performing the process, various components of information will be gathered (e.g., process status, scoring data, venture information, etc.). This information will be stored in database 28 as relationship information.

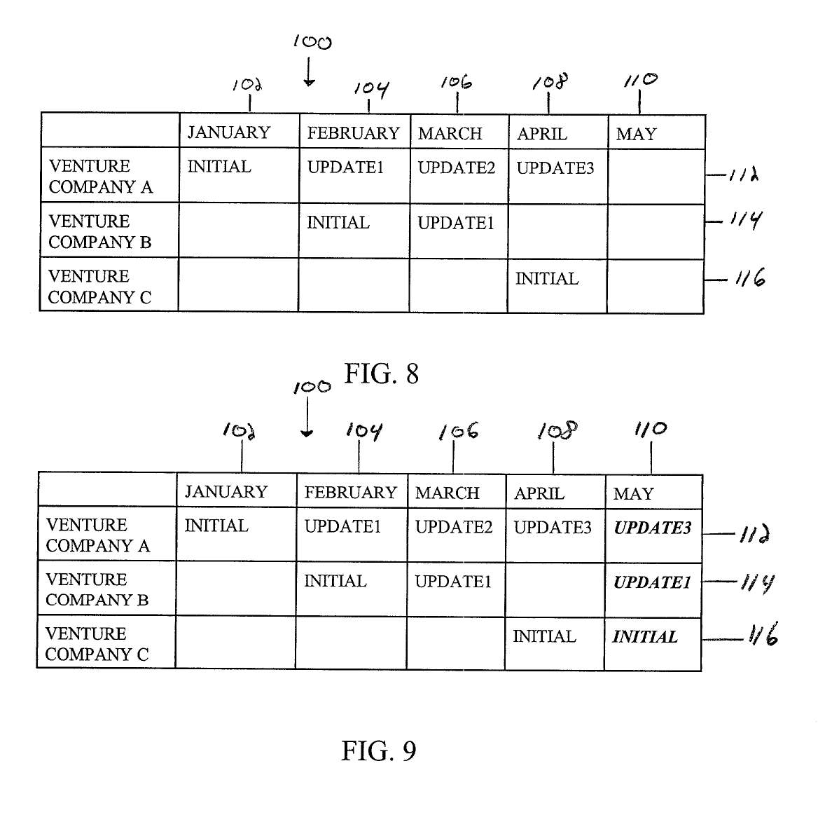

Preferably, database 28 includes a column-row matrix of records for storing the relationship information. Referring to FIG. 8, a column-row matrix 100 is depicted. As shown, matrix 100 includes columns 102, 104, 106, 108, and 110 as well as rows 112, 114, and 116. Preferably, each row corresponds to a separate venture company and each column corresponds to a separate time interval. Specifically, rows 112, 114, and 116 correspond to venture companies A, B, and C, respectively. Moreover, columns 102, 104, 106, 108, and 110 correspond to the months of January, February, March, April, and May, respectively. Each record indicated by INITIAL or UPDATE reflects an entry of relationship information to the particular record. For example, INITIAL entry of column 102, row 112, indicates that a first piece of relationship information for venture company A was entered in January. Moreover, UPDATE1 of column 104, row 112, indicates that the entered relationship information for venture company A was updated in February. When relationship information is entered (i.e., relationship information is initially entered or updated), a current date is assigned. The current date is preferably the date on which the entry was made. For example, UPDATE3 of column 108, row 112, may have a current date of Apr. 1, 2001.

In previous systems data was retrieved for a certain time interval by searching the columns of matrix 100. This resulted in inaccurate information retrieval. Specifically, if the business entity desired to retrieve the relationship information for all ventures companies undergoing the process during the month of April, column 108 would be queried and only relationship information for venture companies A and C would be retrieved. This is because the relationship information for venture company B was neither initially entered nor updated during the month of April. Accordingly, the search would reveal no record of venture company B. In addition, if a business desired to retrieve relationship information for a March-April time interval, two records would be retrieved for venture company A, while only one record would be retrieved for venture companies B and C. Such information retrieval is both confusing and inefficient

The present invention, in contrast, queries matrix 100 by rows instead of by columns so that only a single record is provided for each venture company, regardless of the time interval queried. Thus, if asked to retrieve information for all venture companies undergoing the analysis process during the month of April, rows 112, 114, and 116 would be queried for the most recent initial entering or updating of relationship information for each venture company. This would result in the following records being identified: (1) UPDATE3 in column 108, row 112 for venture A; (2) UPDATE1 in column 106, row 114 for venture company B; and (3) INITIAL in column 108, row 116 for venture company C. This system of querying by rows is provided by row query system 92 of FIG. 7.

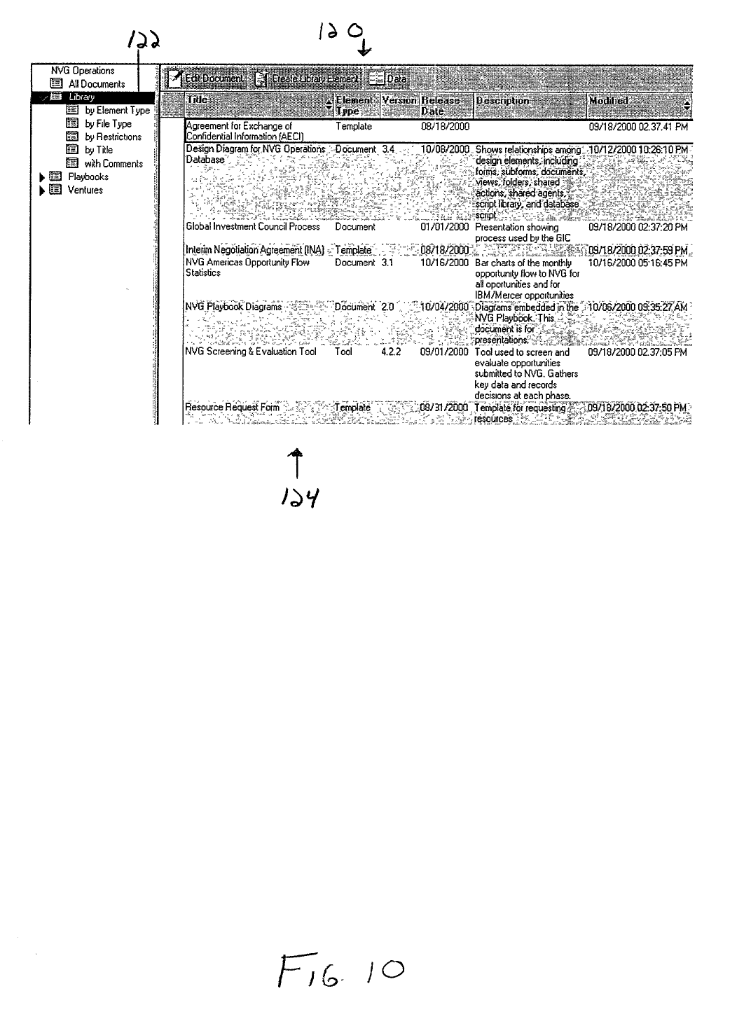

In addition to querying by rows, database management system can duplicate each identified record into another column in the same row so that each record in a column/time interval has an entry. Specifically, referring to FIG. 9, matrix 100 is depicted. As indicated above, row querying identified the records of: (1) UPDATE3 in column 108, row 112 for venture A; (2) UPDATE1 in column 106, row 114 for venture company B; and (3) INITIAL in column 108, row 116 for venture company C. Duplication system 94 (FIG. 7) will duplicate each identified record into the May column 110 of each row. Accordingly, UPDATE3 will be duplicated into column 110, row 112, UPDATE1 will be duplicated into column 110, row 114, and INITIAL will be duplicated into column 110, row 116. Once a record is duplicated, dating system 96 (FIG. 7) will assign an updated current date. For example, for UPDATE3 duplicated to column 110, row 112, the update current date could be May 1, 2001. This will allow each record in a column to have an entry and also allows the business entity to see the date on which the entry was made.

In addition, it should be appreciated that rows and columns could be interchanged without departing from the scope of this invention. For example, ventures could be listed in columns, as opposed to rows. In this case, a single record for each venture would be provided by querying each column.

VII. Views

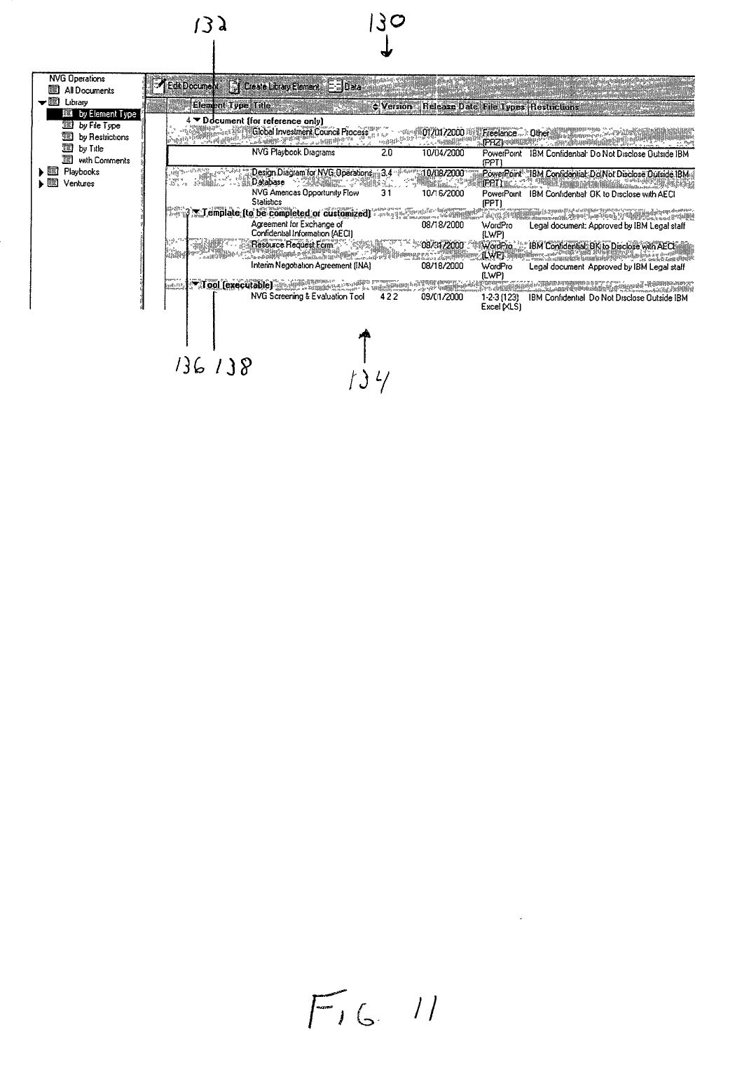

As indicated above, the view system provides the business entity with various view of the process (i.e., process elements), reference documentation, templates, screening tool (i.e., library elements), and relationship information. FIGS. 10-14 depict some of the available views.

Referring first to FIG. 10, a view 120 of library elements is shown. As shown, view 120 presents the business entity with a table of contents 122 for viewing the library elements 124. Specifically, the business entity could view the library element by: (1) element type (e.g., reference documentation, template, screening tool); (2) by file type (e.g., MS Word, Lotus, etc.); (3) by restrictions (e.g., business entity could have restrictions on how a particular library element can be used or who can use it); (4) by title (e.g., in alphabetical order); and (5) and with comments (as indicated above, business entity can add comments to process elements, library elements, or previous comments). View 122 depicts a view of library elements 124 according by title. As can be seen, each library element 124 is listed in alphabetical order.

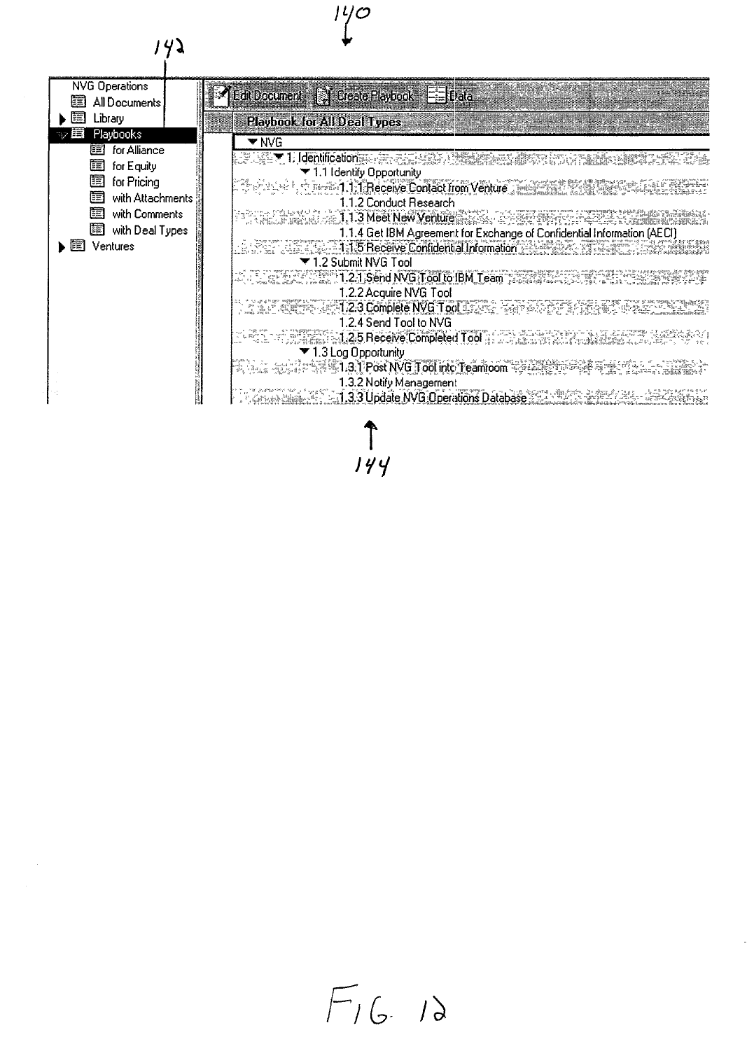

Referring now to FIG. 11, a view 130 of library elements 134 by element type is depicted. As shown, the library elements 134 are listed according to their type, namely, reference document 132, template 136. and screening tool 138.

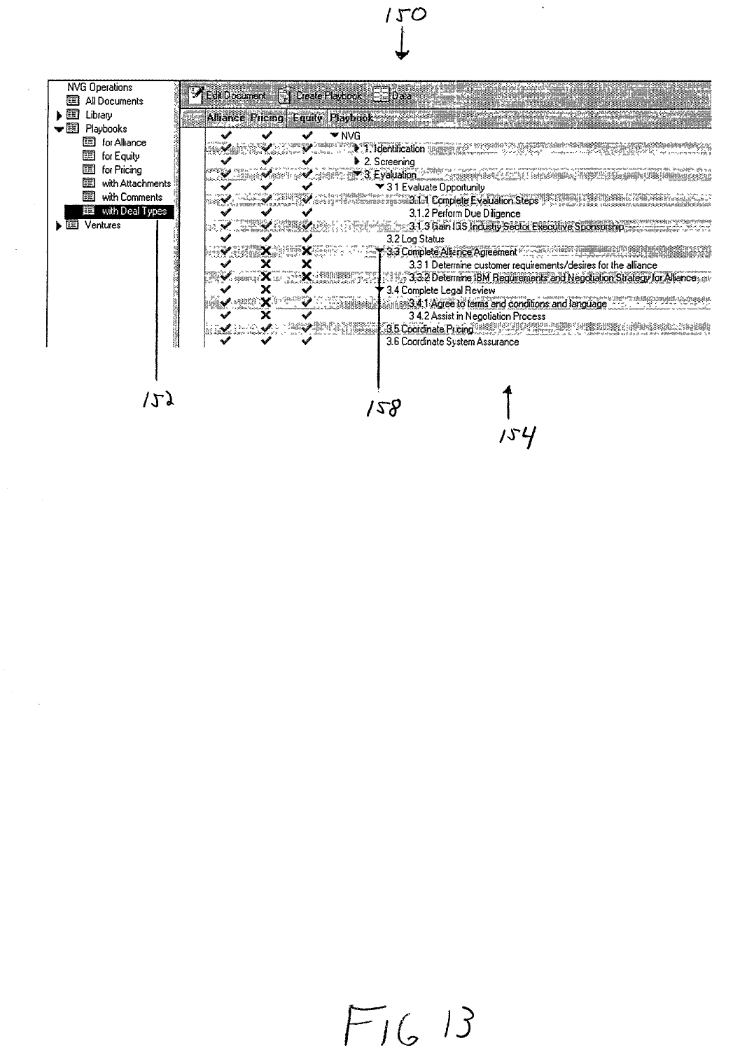

FIG. 12 shows a view 140 of the process (i.e., process elements 144). As shown, view presents the business entity with a table of contents 142 for viewing process elements 144. Specifically, process elements 144 could be viewed for: (1) all relationships; (2) for alliance relationships; (3) for equity relationships; (4) for pricing relationships; (5) with any attachments; (6) with any comments; and (7) with relationship types. View 140 shows process elements 144 for all relationship types.

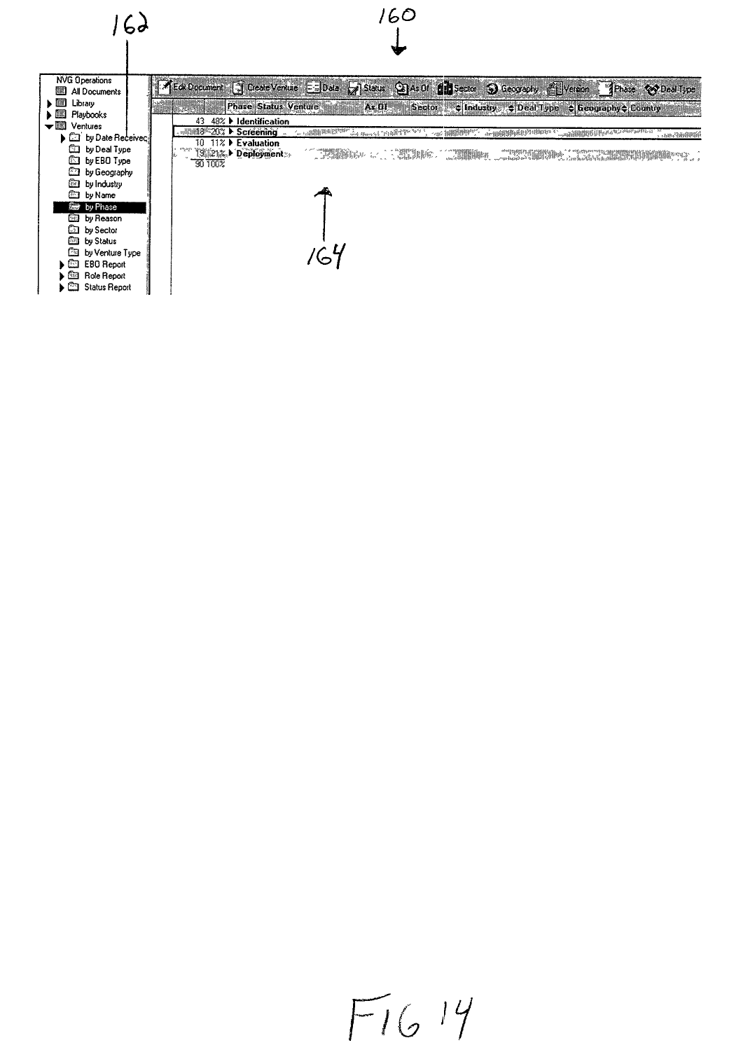

FIG. 13 shows view 150 depicting process elements 154 with relationship types 152. Specifically, view 150 shows process elements 154 and whether they apply to each relationship type (similar to FIGS. 4 and 5 above). As described above, not all process elements 154 apply to all relationship types. For example, the “Complete Alliance Agreement” activity 158 and corresponding tasks do not apply to pricing or equity relationship types.

FIG. 14 shows a view 160 of relationship information. As shown, view 160 presents the business entity with a table of contents 162 for viewing the relationship information 164. For example, relationship information 164 could be viewed according to: (1) date received; (2) relationship type; (3) emerging business opportunity (e.g., biotechnology, etc.); (4) geography; (5) industry; (5) venture company name; (6) phase; (7) reason for rejected a relationship opportunity; (8) grouping of related industries; (9) status; (10) venture type; (11) emerging business opportunity report; (12) role report (i.e., the role the internal group will play with respect to the venture company); and (13) status report (i.e., a printable version of the status). View 160 specifically shows relationship information 164 according to phase. Specifically, of the ninety relationship opportunities being analyzed, 48% are in the identification phase, 20% are in the screening phase, 11% are in the evaluation phase, and 21% are in the deployment phase. It should be understood that these percentages are illustrative only and are not intended to be limiting.

It should be understood that the various tables of contents described above are for illustrative purposes only and could vary. In addition, it should be appreciated that the embodiment of the present invention as computer hardware and/or software is only one preferred embodiment of the present invention. Specifically, the present invention could be carried cut manually (in part or in whole) by an individual or group of individuals (e.g., evaluators(s)). This would require interfacing with venture company 26 to obtain the venture information. Once any necessary information has been obtained, the evaluator(s) could manually perform the analysis and make a set of recommendations.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for managing a relationship with a venture company, comprising the steps of:
providing venture information pertaining to the venture company;
entering the venture information into a database having a column-row matrix of records, wherein the venture information is entered on a current date; and
querying a row of the database to provide a single record of relationship information pertaining to the venture company.

2. The method of claim 1, further comprising the steps of:
providing scoring data based on the venture information; and
entering the scoring data in the database on the current date.

3. The method of claim 1, wherein the venture information comprises a business plan.

4. The method of claim 1, wherein the each row of the matrix corresponds to a separate venture company, and wherein each column of the matrix corresponds to a separate time interval.

5. The method of claim 1, further comprising the steps of:
duplicating the single record from a first column of the queried row to a second column of the queried row; and
assigning an updated current date to the duplicated record.

6. The method of claim 1, further comprising the step of generating reports pertaining to the venture company.

7. The method of claim 1, further comprising the step of analyzing a relationship opportunity with the venture company with the following steps:
identifying the relationship opportunity;
screening the identified opportunity;
evaluating the screened opportunity to determine whether to enter into a business relationship with the venture company; and
deploying the business relationship if the opportunity was positively evaluated.

8. The method of claim 7, wherein the screening step comprises the step of determining scoring data based on the venture information, and wherein the evaluating step comprises the step of determining whether to enter into the business relationship based on the scoring data.

9. A method for managing a relationship with a venture company, comprising the steps of:
providing venture information pertaining to the venture company, and providing scoring data based on the venture information;
entering the venture information and scoring data into a database having a column-row matrix of records, wherein the venture information and scoring data are entered on a current date;
querying a row of the database to provide a single record of relationship information pertaining to the venture company;
duplicating the single record from a first column of the queried row to a second column of the queried row; and
assigning an updated current date to the duplicated record.

10. The method of claim 9, wherein the venture information comprises a business plan.

11. The method of claim 9, wherein the each row of the matrix corresponds to a separate venture company, and wherein each column of the matrix corresponds to a separate time interval.

12. The method of claim 9, further comprising the step of analyzing a relationship opportunity with the venture company with the following steps:
identifying the relationship opportunity;
screening the identified opportunity;
evaluating the screened opportunity to determine whether to enter into a business relationship with the venture company; and
deploying the business relationship if the opportunity was positively evaluated.

13. The method of claim 12, wherein the screening step comprises the step of determining scoring data based on the venture information, and wherein the evaluating step comprises the step of determining whether to enter into the business relationship based on the scoring data.

14. A method for analyzing a relationship opportunity with a venture company comprising the steps of:
identifying a relationship opportunity with a venture company and obtaining venture information about the venture company;
logging an identification status in a database;
calculating scoring data based on the venture information;
logging a screening status in the database;
evaluating the scoring data to determine whether to form a business relationship with the venture company;
logging an evaluation status in the database; and
deploying the business relationship if the scoring data was positively evaluated.

15. A system for managing a relationship with a venture company, comprising:
a process system for analyzing a relationship opportunity with a venture company;
a library system for providing library elements; and
a view system for providing a plurality of views of the process, and the library elements.

16. The system of claim 15, wherein the process system comprises:
an identification system for providing identification process elements for identifying a relationship opportunity with a venture company;
a screening system for providing screening process elements for screening an identified opportunity;
an evaluation system for providing evaluation process elements for evaluating a screened opportunity to determine whether to enter into a business relationship with the venture company; and
a deployment system for providing deployment process elements for deploying a business relationship for a positively evaluated opportunity.

17. The system of claim 15, wherein the library system comprises:
a reference system for providing reference documentation;
a template system for providing templates; and
a screening tool system for providing venture information about the venture company.

18. The system of claim 15, further comprising a database system for managing a relationship information corresponding to the process, wherein the database system comprises:
a database comprising a column-row matrix of records, wherein each row corresponds to a separate venture company and each column corresponds to a separate time interval;
a row query system for querying a row of the matrix to provide a single record of relationship information corresponding to a particular venture company at a predetermined time interval;
a duplication system for duplicating a provided single record from a first column of a queried row to a second column of the queried row; and
a dating system for assigning an updated current date to a duplicated record.

19. The system of claim 18, wherein the view system further provides a plurality of views of the relationship information.

20. The database system of claim 18, wherein the relationship information comprises status information.

21. A system for managing a relationship with a venture company, comprising:
a process system for analyzing a relationship opportunity with a venture company;
a library system for providing reference documentation, templates, and a screening tool;
a database system for managing relationship information corresponding to the process; and
a view system for providing a plurality of views of the process, the reference documentation, the templates, the screening tool, and the relationship information.

22. The system of claim 21, wherein the process system comprises:
an identification system for providing identification process elements for identifying a relationship opportunity with a venture company;
a screening system for providing screening process elements for screening an identified opportunity;
an evaluation system for providing evaluation process elements for evaluating a screened opportunity to determine whether to enter into a business relationship with the venture company; and
a deployment system for providing deployment process elements for deploying a business relationship for a positively evaluated opportunity.

23. The system of claim 21, wherein the library system comprises:
a reference system for providing reference documentation;
a template system for providing templates; and
a screening tool system for providing venture information about the venture company.

24. The system of claim 21, wherein the database system comprises:
a database having a column-row matrix of records, wherein each row corresponds to a separate venture company and each column corresponds to a separate time interval;
a row query system for querying a row of the matrix to provide a single record of relationship information corresponding to a particular venture company at a predetermined time interval;
a duplication system for duplicating a provided single record from a first column of a queried row to a second column of the queried row; and
a dating system for assigning an updated current date to a duplicated record.

25. The system of claim 24, wherein the relationship information comprises status information.

26. A system for managing a relationship with a venture company, comprising:
a process system for analyzing a relationship opportunity with a venture company;
a library system for providing reference documentation, templates, and a screening tool;
a database system for managing relationship information corresponding to the process, wherein the database system comprises:
a database having a column-row matrix of records, wherein each row corresponds to a separate venture company, and wherein each column corresponds to a separate time interval;
a row query system for querying a row of the matrix to provide a single record of relationship information corresponding to a particular venture company at a predetermined time interval;
a duplication system for duplicating a provided single record from a first column of a queried row to a second column of the queried row;
a dating system for assigning an updated current date to a duplicated record; and
a view system for providing a plurality of views of the process, the reference documentation, the templates, the screening tool, and the relationship information.

27. A database system for managing relationship information corresponding to a process for analyzing a relationship opportunity with a venture company, comprising:
a database having a column-row matrix of records, wherein each row corresponds to a separate venture company, and wherein each column corresponds to a separate time interval; and
a row query system for querying a row of the matrix to provide a single record of relationship information corresponding to a particular venture company at a predetermined time interval.

28. The database system of claim 27, further comprising:
a duplication system for duplicating a provided single record from a first column of a queried row to a second column of the queried row; and
a dating system for assigning an updated current date to a duplicated record.

29. The database system of claim 27, wherein the relationship information comprises status information and the venture information.

30. A database system for managing relationship information corresponding to a process for analyzing a relationship opportunity with a venture company, comprising:
a database having a column-row matrix of records, wherein each row corresponds to a separate venture company, and wherein each column corresponds to a separate time interval;
a row query system for querying a row of the matrix to provide a single record of relationship information corresponding to a particular venture company at a predetermined time interval;
a duplication system for duplicating a provided single record from a first column of a queried row to a second column of the queried row; and
a dating system for assigning an updated current date to a duplicated record.

31. The database system of claim 30, wherein the relationship information comprises status information and the venture information.

32. A program product stored on a recordable medium for managing a relationship with a venture company, comprising:
a process system for analyzing a relationship opportunity with the venture company;
a library system for providing reference documentation, templates and a screening tool; and
a view system for providing a plurality of views of the process, the reference documentation, the templates, and the screening tool.

33. The program product of claim 32, wherein the process system comprises:
an identification system for providing identification process elements for identifying a relationship opportunity with a venture company;
a screening system for providing screening process elements for screening an identified opportunity;
an evaluation system for providing evaluation process elements for evaluating a screened opportunity to determine whether to enter into a business relationship with the venture company; and
a deployment system for providing deployment process elements for deploying a business relationship for a positively evaluated opportunity.

34. The program product of claim 32, wherein the library system comprises:
a reference system for providing the reference documentation;
a template system for providing the templates; and
a screening tool system for gathering venture information about the venture company.

35. The program product of claim 34, further comprising a database system for managing relationship information pertaining to the process, wherein the database system comprises:
a database comprising a column-row matrix of records, wherein each row corresponds to a separate venture company and each column corresponds to a separate time interval;
a row query system for querying a row of the matrix to provide a single record of relationship information corresponding to a particular venture company at a predetermined time interval;
a duplication system for duplicating a provided single record from a first column of a queried row to a second column of the queried row; and
a dating system for assigning an updated current date to a duplicated record.
